(19) United States
(12) Patent Application Publication
(10) Pub. No.: US 2018/0335174 A1
(43) Pub. Date: Nov. 22, 2018

(54) BRANCH PIPE AND BRANCH PIPE FOR MULTI-TYPE AIR CONDITIONER

(71) Applicant: KAKINUMA KINZOKU SEIKI CO., LTD., Tokyo (JP)

(72) Inventor: Osamu KAKINUMA, Tokyo (JP)

(21) Appl. No.: 15/978,884

(22) Filed: May 14, 2018

(30) Foreign Application Priority Data
May 22, 2017 (JP) 2017-100549
Jun. 30, 2017 (JP) 2017-128192

(51) Int. Cl. F16L 41/02

(52) U.S. Cl. CPC F16L 41/021; F25B 41/003

(57) ABSTRACT

A branch pipe branches fluid from an inflow portion into a first outflow portion and a second outflow portion. The middle portion of the first outflow portion is curved so that the axis of the pipe at the outlet of the first outflow portion is aligned with the axis of the pipe of the inflow portion.

### CROSS-REFERENCE TO RELATED APPLICATION

The present application claims priorities of Japanese Patent Applications No. 2017-100549 filed on May 22, 2017 and No. 2017-128192 filed on Jun. 30, 2017, the disclosure of which is incorporated herein.

### BACKGROUND OF THE INVENTION

### Technical Field

The present invention relates to a branch pipe and a branch pipe for a multi-type air conditioner, and in particular, to a branch pipe and a branch pipe for multi-type air conditioner having good usability.

### Related Art

Conventionally, in a multi-type air conditioner, a branch pipe S′ shown in FIG. 10 is used to branch a refrigerant.

In FIG. 11, for example, an indoor unit of a multi-type air conditioner is installed on each floor, and four branch pipes S′ are connected in series.

### SUMMARY OF THE INVENTION

Therefore, when the above mentioned branch pipe S′ is used, the axis offset O′O″, which is (L/2)×3, occurs.

This axis offset O′O″ means that the positions of piping are different when the piping passes through the floor and the ceiling of each floor, which makes it difficult to install the piping. Thus, there is the problem that the above mentioned branch pipe does not have good usability.

It is an object of the present invention to provide a branch pipe and a branch pipe for a multi-type air conditioner which are made in consideration of the above problems.

A branch pipe of a first aspect of the present invention branches fluid from an inflow portion into a first outflow portion and a second outflow portion. An inlet of the inflow portion and an outlet of the first outflow portion communicate with each other. The inlet of the inflow portion and an outlet of the second outflow portion communicate with each other. A middle portion of the first outflow portion is bent so that an axis of the branch pipe at an outlet of the first outflow portion is aligned with an axis of the branch pipe at the inflow portion.

The branch pipe of a second aspect of the present invention branches fluid from an inflow portion into a first outflow portion and a second outflow portion. The branch pipe includes a first connection pipe connected to the first outflow portion. An inlet of the inflow portion and an outlet of the first connection pipe communicate with each other. The inlet of the inflow portion and an outlet of the second outflow portion communicate with each other. A middle portion of the first connection pipe is bent so that an axis of the branch pipe at an outlet of the first connection pipe is aligned with an axis of the branch pipe at the inflow portion.

The branch pipe of a third aspect of the present invention is configured such that, in the branch pipe of the first or second aspect, an inner wall of the inflow portion and an outer wall of the inflow portion, an inner wall of the first outflow portion and an outer wall of the first outflow portion, and an inner wall of the second outflow portion and an outer wall of the second outflow portion are continuously connected with each other with a same material. The inner wall of the first outflow portion and the inner wall of the second outflow portion are connected with each other in an R shape.

The branch pipe of a fourth aspect of the present invention is configured such that, in the branch pipe of the first or second aspect, the branch pipe includes a second connection pipe connected to the second outflow portion. An angle formed by an extension line of the axis of the branch pipe at the inflow portion and the axis of the branch pipe at the outlet of the second outflow portion is 45 degrees. A middle portion of the second connection pipe is bent. The bent second connection pipe includes one part of the second connection pipe and the other part of the second connection pipe. The one part of the second connection pipe is close to the second outflow portion and the other part of the second connection pipe is away from the second outflow portion. An angle formed by an extension line of a longitudinal axis of the one part of the second connection pipe and a longitudinal axis of the other part of the second connection pipe is 45 degrees.

A multi-type air conditioner branch pipe of a fifth aspect of the present invention branches fluid from an inflow portion into a first outflow portion and a second outflow portion. An inlet of the inflow portion and an outlet of the first outflow portion communicate with each other. The inlet of the inflow portion and an outlet of the second outflow portion communicate with each other. A middle portion of the first outflow portion is bent so that an axis of the branch pipe at an outlet of the first outflow portion is aligned with an axis of the branch pipe at the inflow portion. A linear second connection pipe is connected to the first outflow portion and a third connection pipe is not connected to the second outflow portion prior to an installation work. An axis of the linear second connection pipe is aligned with an axis of the branch pipe at the inflow portion.

A multi-type air conditioner branch pipe of a sixth aspect of the present invention branches fluid from an inflow portion into a first outflow portion and a second outflow portion. The branch pipe includes a first connection pipe connected to the first outflow portion. The inlet of the inflow portion and an outlet of the first connection pipe communicate with each other. The inlet of the inflow portion and an outlet of the second outflow portion communicate with each other. A middle portion of the first connection pipe is bent so that an axis of the branch pipe at an outlet of the first connection pipe is aligned with an axis of the branch pipe at the inflow portion. A linear fourth connection pipe is connected to the first connection pipe and a third connection pipe is not connected to the second outflow portion prior to an installation work. An axis of the linear fourth connection pipe is aligned with an axis of the branch pipe at the inflow portion.

According to the branch pipe of the first aspect, the middle portion of the first outflow portion is curved so that the axis of the branch pipe at the outlet of the first outflow portion is aligned with the axis of the branch pipe at the inflow portion. That is, since the branch pipe at the inflow portion and the branch pipe at the outlet of the first outflow portion can be positioned in the same axis, for example, when installing multi-type air conditioners in rooms in a multi-floor building or side by side rooms, with respect to the branch pipe according to the first aspect, the position of the piping (the position of the piping hole of the ceiling, the position of the piping hole of the wall) forms a linear line, and it is possible to provide a convenient branch pipe which can facilitate the installation work of the multi-type air conditioner.

Further, according to the branch pipe of the second aspect, a middle portion of the first connection pipe is bent so that a longitudinal axis of the branch pipe at the outlet of the first connection pipe is aligned with a longitudinal axis of the branch pipe at the inflow portion. That is, since the branch pipe at the inflow portion and the branch pipe at the outlet of the first connection pipe can be positioned in the same axis, for example, when installing multi-type air conditioners in rooms in a multi-floor building or side by side rooms, with respect to the branch pipe according to the second aspect, the position of the piping (the position of the piping hole of the ceiling, the position of the piping hole of the wall) forms a linear line, and it is possible to provide a convenient branch pipe which can facilitate the installation work of the multi-type air conditioner.

According to the branch pipe of the third aspect, in addition to the effects of the above-described first or second aspect, the inner wall of the inflow portion and the outer wall of the inflow portion, the inner wall of the first outflow portion and the outer wall of the first outflow portion, and the inner wall of the second outflow portion and the outer wall of the second outflow portion are continuously connected with each other with the same material, and the inner wall of the first outflow portion and the inner wall of the second outflow portion are connected with each other in an R shape. Thus, it is possible to provide a branch pipe with good usability with less pressure loss.

According to the branch pipe of the fourth aspect, in addition to the effects of the above-described first or second aspect, the branch pipe includes a second connection pipe connected to the second outflow portion. An angle formed by an extension line of the axis of the branch pipe at the inflow portion and the axis of the branch pipe at the outlet of the second outflow portion is 45 degrees. A middle portion of the second connection pipe is bent. The bent second connection pipe includes one part of the second connection pipe and the other part of the second connection pipe. The one part of the second connection pipe is close to the second outflow portion and the other part of the second connection pipe is away from the second outflow portion. An angle formed by an extension line of a longitudinal axis of the one part of the second connection pipe and a longitudinal axis of the other part of the second connection pipe is 45 degrees. As a result, when the second connection pipe is not used for outward branching, the second connection pipe can be rotated so that an angle formed by the axis of the branch pipe at the outlet of the second connection pipe (the other portion of the second connection pipe) and the axis of the branch pipe at the inflow portion is made parallel, and when using the second connection pipe for outward branching, the second connection pipe can be rotated so that an angle formed by the axis of the branch pipe at the outlet of the second connection pipe (the other portion of the second connection pipe) and the axis of the branch pipe at the inflow portion is made to be 90 degrees. Thus, it is possible to provide a branch pipe with good usability.

According to the fifth aspect of the branch pipe for multi-type air conditioner, a linear second connection pipe is connected to the first outflow portion and a third connection pipe is not connected to the second outflow portion prior to an installation work. An axis of the linear second connection pipe is aligned with an axis of the branch pipe at the inflow portion. As a result, regardless of whether the third connection pipe is branched from the second outflow portion, the position of the linear second connection pipe connected to the first outflow portion is determined, so that it is possible to shorten the time for connecting the linear second connection pipe to the first outflow portion at the time of installation work. When installing multi-type air conditioners in rooms in a multi-floor building or side by side rooms, the piping position (the position of the piping hole of the ceiling, the position of the piping hole of the wall) forms a linear line, and it is possible to provide a convenient branch pipe which can facilitate the installation work of the multi-type air conditioner.

Further, according to the sixth aspect branch pipe for multi-type air conditioner, prior to the installation work, a linear fourth connection pipe is connected to the first connection pipe and a third connection pipe is not connected to the second outflow portion prior to an installation work. An axis of the linear fourth connection pipe is aligned with an axis of the branch pipe at the inflow portion. As a result, regardless of whether the third connection pipe is branched from the second outflow portion, the position of the linear fourth connection pipe connected to the first connection pipe is determined, so that it is possible to shorten the time for connecting the linear fourth connection pipe to the first connection branch pipe at the time of installation work. When installing multi-type air conditioners in rooms in a multi-floor building or side by side rooms, the piping position (the position of the piping hole of the ceiling, the position of the piping hole of the wall) forms a linear line, and it is possible to provide a convenient branch pipe which can facilitate the installation work of the multi-type air conditioner.

### BRIEF DESCRIPTION OF DRAWINGS

FIG. 1 is a schematic view showing a branch pipe according to an embodiment of the present invention;

FIG. 2 is a schematic view of one mode of use of the branch pipe of FIG. 1;

FIG. 3 is a schematic view of another form different from the branch pipe of FIG. 1;

FIG. 4 is a schematic view of another form different from the use form of the branch pipe of FIG. 2, and shows a state before construction;

FIG. 5 is a schematic view showing a state after the construction of FIG. 4;

FIG. 6 is a schematic view of the use form of the branch pipe of FIG. 3, and shows a state before construction;

FIG. 7 is a schematic view showing a state after the construction of FIG. 6;

FIG. 8 is a schematic view of a state in which a branch pipe is covered with a coated insulation material;

FIG. 9 is a schematic view showing a state before the exposed portion of FIG. 8 is covered with the coated insulation material;

FIG. 10 is a schematic view of a conventional branch pipe; and

FIG. 11 is a schematic view of one mode of use of the branch pipe of FIG. 10.

### DETAILED DESCRIPTION OF THE INVENTION

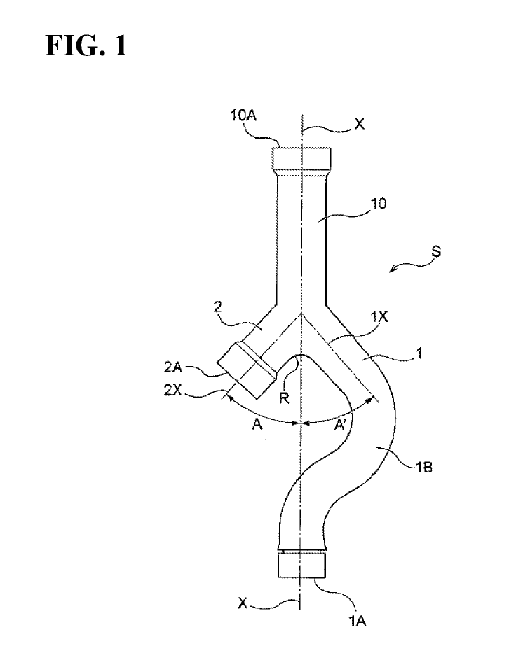

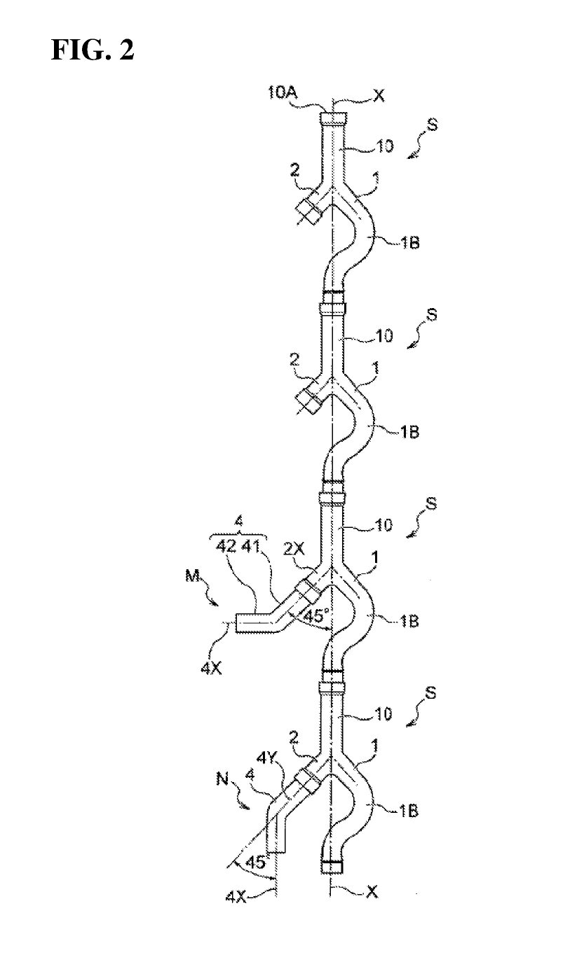

A branch pipe and a branch pipe for a multi-type air conditioner according to an embodiment of the present invention will be described with reference to the drawings (FIGS. 1 and 2).

FIG. 1 is a schematic view of a branch pipe (branch pipe for multi-type air conditioner) S of the present invention. The branch pipe S branches fluid from an inflow portion 10 into a first outflow portion 1 and a second outflow portion 2. The inlet of the inflow portion 10 communicates with the outlet of the first outflow portion 1, and the inlet of the inflow portion 10 and the outlet of the second outflow portion 2 communicate with each other. The branch pipe S is, for example, incorporated in a refrigeration cycle of a multi-type air conditioner, and is used for diverting the refrigerant.

The middle portion of the first outflow portion 1 is curved so that the axis X of a pipe 1A at the outlet of the first outflow portion 1 is aligned with the axis X of a pipe 10A at the inflow portion 10. 1B shown in FIG. 1 is a curved portion.

Since the pipe 10A at the inflow portion 10 and the pipe 1A at the outlet of the first outflow portion 1 can be positioned in the same axis X in this way, for example, when installing multi-type air conditioners in rooms in a multi-floor building or side by side rooms, with respect to branch pipe S, the piping position (the position of the piping hole of the ceiling, the position of the piping hole of the wall) forms a linear line as shown in FIG. 2, and it is possible to provide a convenient branch pipe S which can facilitate the installation work of the multi-type air conditioner.

Although in FIG. 2, the branch pipes S are sequentially juxtaposed to make the explanation easy to understand, and a linear piping is appropriately positioned between the adjacent branch pipes S.

Although not shown, the branch pipe S shown in FIG. 1 can be formed by compressing the both ends of the copper pipe in the axial direction while filling the copper pipe set in the mold with the liquid of ultra-high pressure, and processing it into a shape engraved in the mold, so-called bulging process.

The angle A formed by the extension line of the axis X of the pipe 10A at the inflow portion 10 and the axis 2X of a pipe 2A at the outlet of the second outflow portion 2 is an acute angle, for example 45 degrees. An angle A′ formed by an extension line of the axis X of the pipe 10A of the inflow portion 10 and the axis 1X of the branch pipe at the inlet of the first outflow portion 1 is an acute angle, for example, 45 degrees. In the present embodiment, A=A′. It is not necessarily required that A=A′.

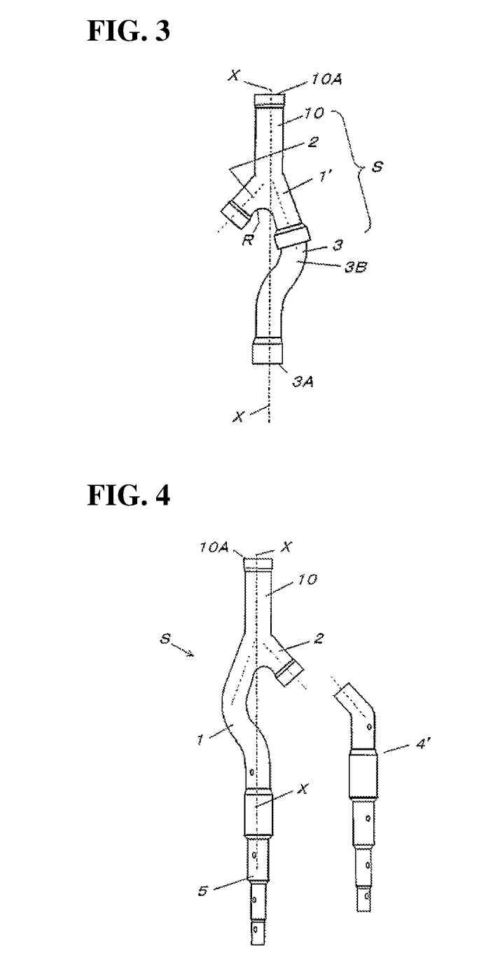

Although the branch pipe S shown in FIG. 1 is integrally formed, the present invention is not limited to this configuration. For example, as shown in FIG. 3, the first outflow portion 1 of the branch pipe S may be formed of two members.

That is, a first connection pipe 3 is connected to the first outflow portion 1′ which is shorter than the first outflow portion 1 shown in FIG. 1. The middle portion of the first connection pipe 3 is curved so that the axis X of a pipe 3A at the outlet of the first connection pipe 3 is aligned with the axis X of the pipe 10A at the inflow portion 10. Reference numeral 3B shown in FIG. 3 is a curved portion.

For the branch pipe S shown in FIG. 3, the inlet of the inflow portion 10 communicates with the outlet of the first connection pipe 3, and the inlet of the inflow portion 10 and the outlet of the second outflow portion 2 communicate with each other.

For the branch pipe S shown in FIG. 3 as in the branch pipe S shown in FIG. 1, since the pipe 10A at the inflow portion 10 and the pipe 3A at the outlet of the first connection pipe 3 can be positioned in the same axis X, for example, when installing multi-type air conditioners in rooms in a multi-floor building or side by side rooms, with respect to branch pipe S, the piping position (the position of the piping hole of the ceiling, the position of the piping hole of the wall) forms a linear line as shown in FIG. 2, and it is possible to provide a convenient branch pipe S which can facilitate the installation work of the multi-type air conditioner.

Further, in the branch pipe S shown in FIGS. 1 and 3, the inner wall of the inflow portion 10 and the outer wall of the inflow portion 10, the inner wall of the first outflow portion 1 and the outer wall of the first outflow portion 1, and the inner wall of the second outflow portion 2 and the outer wall of the second outflow portion 2 are continuously connected with each other with the same material (for example, copper), and the inner wall of the first outflow portion 1 and the second outflow portion 2 are connected in an R shape. In the branch pipe S shown in FIGS. 1 and 3, the inner wall of the first outflow portion 1 and the inner wall of the second outflow portion 2 are not shown. An R shaped portion connecting the inner wall of the first outflow portion 1 and the inner wall of the second outflow portion 2 are formed along the R-shaped portion R (FIGS. 1 and 3) of the outer wall of the first outflow portion 1 and the outer wall of the second outflow portion 2.

As shown in FIG. 2, when a second connection pipe 4 is not used for outward branching (refer to N in FIG. 2), the second connection pipe 4 is rotated and an angle formed by the axis 4X of the branch pipe at the outlet of the second connection pipe 4 (the longitudinal axis 4X of one part of the bent second connection pipe 4) and the axis X of the branch pipe at the inflow portion 10 is made parallel. When the second connection pipe 4 is used for outward branching (refer to M in FIG. 2), the second connection pipe 4 is rotated and an angle formed by the axis 4X of the branch pipe at the outlet of the second connection pipe 4 (the longitudinal axis 4Y of the other part of the bent second connection pipe 4) and the axis X of the branch pipe at the inflow portion 10 is made to be 90 degrees. As a result, it is possible to provide a branch pipe S with good usability.

For this purpose, the angle formed by the extension line of the axis X of the pipe 10A at the inflow portion 10 and the axis 2X of the pipe 2A at the outlet of the second outflow portion 2 is 45 degrees (see M in FIG. 2), the middle portion of the second connection pipe 4 connected to the second outflow portion 2 is bent, the bent second connection pipe 4 includes one part of the second connection pipe 41 and the other part of the second connection pipe 42, the one part of the second connection pipe 41 is close to the second outflow portion 4 and the other part of the second connection pipe 42 is away from the second outflow portion 4, and an angle formed by the extension line of a longitudinal axis of the one part of the second connection pipe 41 and a longitudinal axis of the other part of the second connection pipe 42 is 45 degrees (see N in FIG. 2).

As shown in FIG. 4, prior to the installation work, a linear third connection pipe 5 is connected to the first outflow portion 1, and a second connection pipe 4′ is not connected to the second outflow portion 2, and the axis X of the linear third connection pipe 5 is made to be aligned with the axis X of the pipe 10A at the inflow portion 10.

Since the axis X of the linear third connection pipe 5 is aligned with the axis X of the pipe 10A at the inflow portion 10, regardless of whether the second’ connection pipe 4′ is branched from the second outflow portion 2, the position of the linear third connection pipe 5 connected to the first outflow portion 1 is determined, as shown in FIG. 4. As a result, it is possible to shorten the time for connecting the linear third connection pipe 5 to the first outflow portion 1 at the time of installation work, and to provide the branch pipe S with good usability.

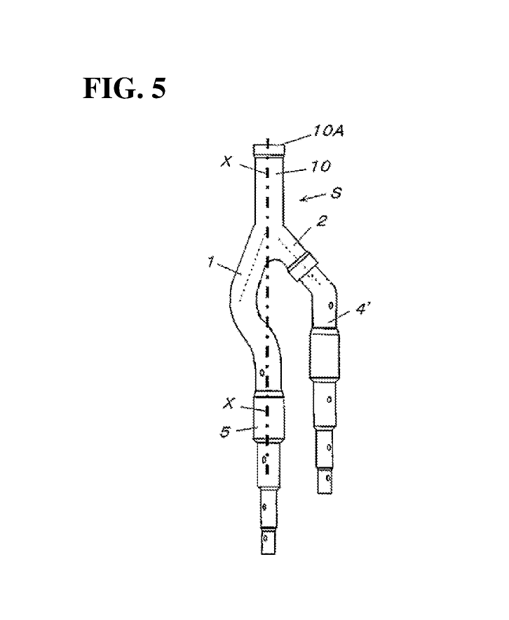

When it is not necessary to branch the second connection pipe 4′ from the second outflow portion 2, the second connection pipe 4′ is connected to the second outflow portion 2 when the installation work is carried out, as shown in FIG. 5.

This can be applied similarly to the branch pipe S shown in FIG. 3.

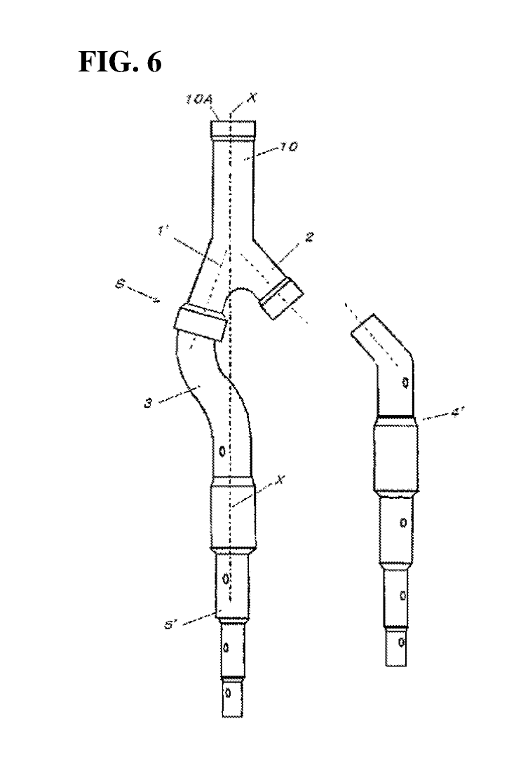

That is, as shown in FIG. 6, prior to the installation work, a linear fourth connection pipe 5′ is connected to the first connection pipe 3, the second’ connection pipe 4′ is not connected to the second outflow portion 2, and the axis X of the linear fourth connection pipe 5′ is made to be aligned with the axis X of the pipe 10A at the inflow portion 10.

Since the axis X of a linear fourth connection pipe 5′ is aligned with the axis X of the pipe 10A at the inflow portion 10, regardless of whether the second connection pipe 4′ is branched from the second outflow portion 2, the position of the linear fourth connection pipe 5′ connected to the first connection pipe 3 is determined, as shown in FIG. 6. As a result, it is possible to shorten the time for connecting the linear fourth connection pipe 5′ to the first connection pipe 3 at the time of installation work, and to provide the branch pipe S with good usability.

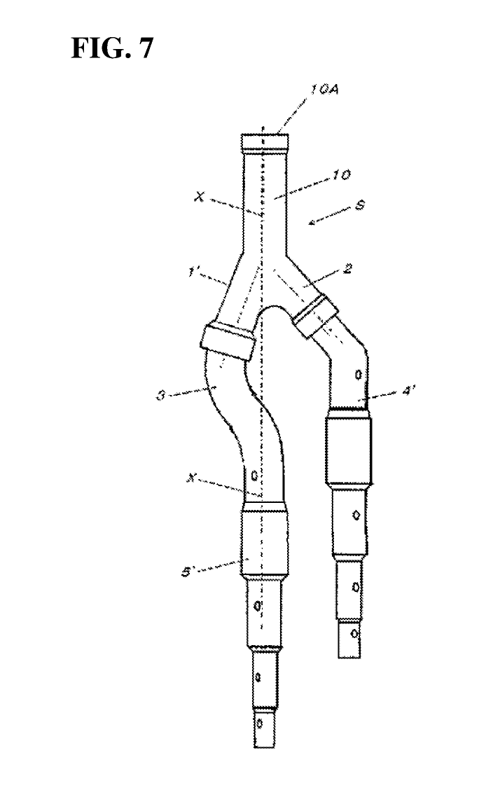

When it is not necessary to branch the second connection pipe 4′ from the second outflow portion 2, the second connection pipe 4′ is connected to the second outflow portion 2 when the installation work is carried out, as shown in FIG. 7.

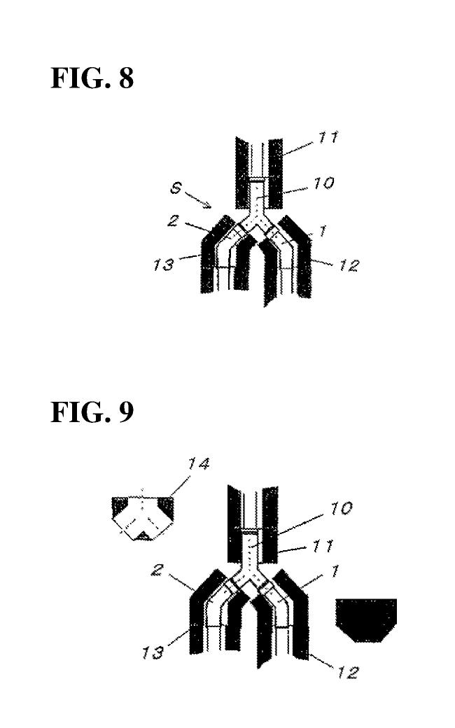

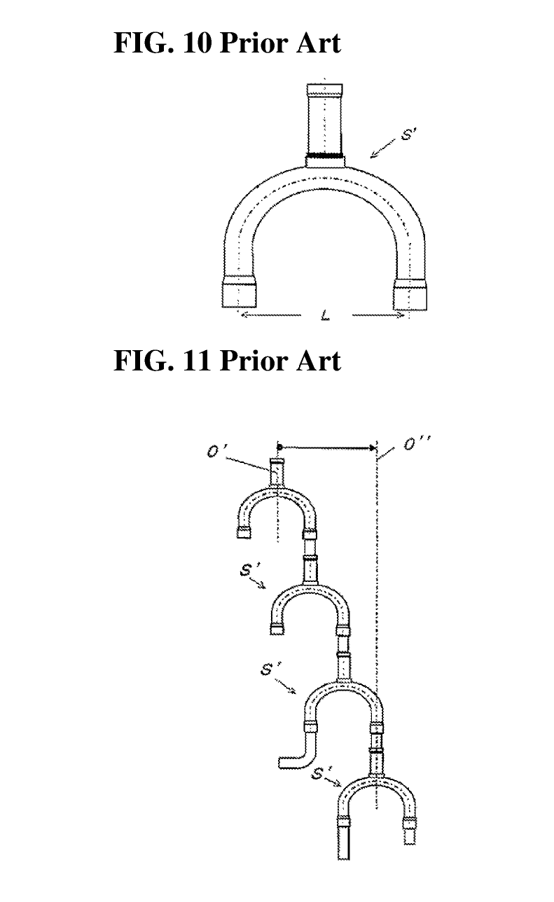

In addition, reference numeral 11 shown in FIG. 8 is an inflow portion insulation material covering the inflow portion 10, reference numeral 12 is a first outflow portion insulation material covering the first outflow portion 1, and reference numeral 13 is a second outflow portion insulation material covering the second outflow portion 2. Since the branch pipe S is covered with an inflow portion insulation material 11, an outflow portion insulation material 12, and a second outflow portion insulation material 13, heat loss of the branch pipe S can be prevented.

Numeral 14 shown in FIG. 9 is a bifurcated portion insulation material covering a portion of the branch portion S where the portion of the branch portion S is not covered with the inflow portion insulation material 11, the first outflow portion insulation material 12, and the second outflow portion insulation material 13.

Since the branch pipe S is covered with the inflow portion insulation material 11, the outflow portion insulation material 12, the second outflow portion insulation material 13, and a bifurcated portion insulation material 14, heat loss of the branch pipe S can be further prevented.

### REFERENCE SIGNS LIST

S Branch pipe
1 First outflow portion
2 Second outflow portion
1A Branch pipe at the outlet of the first outflow portion
10A Branch pipe at the inflow portion
X Axis of the branch pipe at the outlet of the first outflow portion
X Axis of the branch pipe at the inflow portion

What is claimed is:

1. A branch pipe comprising:
an inflow portion, a first outflow portion and a second outflow portion, for branching fluid from the inflow portion into the first outflow portion and the second outflow portion,
wherein an inlet of the inflow portion and an outlet of the first outflow portion communicate with each other,
the inlet of the inflow portion and an outlet of the second outflow portion communicate with each other, and
a middle portion of the first outflow portion is bent so that an axis at the outlet of the first outflow portion is aligned with an axis at the inflow portion.

2. A branch pipe comprising:
an inflow portion, a first outflow portion, a second outflow portion, and a first connection pipe, for branching fluid from the inflow portion into the first outflow portion and the second outflow portion,
wherein the first connection pipe is connected to the first outflow portion,
an inlet of the inflow portion and an outlet of the first connection pipe communicate with each other,
the inlet of the inflow portion and an outlet of the second outflow portion communicate with each other, and
a middle portion of the first connection pipe is bent so that an axis at the outlet of the first connection pipe is aligned with an axis at the inflow portion.

3. A branch pipe according to claim 1,
wherein an inner wall of the inflow portion, an outer wall of the inflow portion, an inner wall of the first outflow portion, an outer wall of the first outflow portion, an inner wall of the second outflow portion, an outer wall of the second outflow portion are continuously connected with each other with a same material, and
the inner wall of the first outflow portion and the inner wall of the second outflow portion are connected with each other in an R shape.

4. A branch pipe according to claim 1, further comprising a connection pipe connected to the second outflow portion,
wherein an angle formed by an extension line of the axis at the inflow portion and the axis at the outlet of the second outflow portion is 45 degrees,
a middle portion of the connection pipe is bent, and the bent connection pipe includes one part of the connection pipe and another part of the connection pipe,
the one part of the connection pipe is close to the second outflow portion and the another part of the connection pipe is away from the second outflow portion, and
an angle formed by an extension line of a longitudinal axis of the one part of the connection pipe and a longitudinal axis of the another part of the connection pipe is 45 degrees.

5. A multi-type air conditioner branch pipe, comprising:
an inflow portion, a first outflow portion, a second outflow portion, and linear first and second connection pipes, for branching fluid from the inflow portion into the first outflow portion and the second outflow portion,
wherein an inlet of the inflow portion and an outlet of the first outflow portion communicate with each other,
the inlet of the inflow portion and an outlet of the second outflow portion communicate with each other,
a middle portion of the first outflow portion is bent so that an axis at the outlet of the first outflow portion is aligned with an axis at the inflow portion,
the linear first connection pipe is connected to the first outflow portion and the second connection pipe is not connected to the second outflow portion prior to an installation work, and
an axis of the linear first connection pipe is aligned with the axis at the inflow portion.

6. A multi-type air conditioner branch pipe, comprising:
an inflow portion, a first outflow portion, a second outflow portion, a first connection pipe, a second connection pipe, and a linear connection pipe, for branching fluid from the inflow portion into the first outflow portion and the second outflow portion,
wherein the first connection pipe is connected to the first outflow portion,
an inlet of the inflow portion and an outlet of the first connection pipe communicate with each other,
the inlet of the inflow portion and an outlet of the second outflow portion communicate with each other,
a middle portion of the first connection pipe is bent so that an axis at the outlet of the first connection pipe is aligned with an axis at the inflow portion,
the linear connection pipe is connected to the first connection pipe and the second connection pipe is not connected to the second outflow portion prior to an installation work, and
an axis of the linear connection pipe is aligned with an axis at the inflow portion.

7. A branch pipe according to claim 2,
wherein an inner wall of the inflow portion, an outer wall of the inflow portion, an inner wall of the first outflow portion, an outer wall of the first outflow portion, an inner wall of the second outflow portion, an outer wall of the second outflow portion are continuously connected with each other with a same material, and
the inner wall of the first outflow portion and the inner wall of the second outflow portion are connected with each other in an R shape.

8. A branch pipe according to claim 2, further comprising a second connection pipe connected to the second outflow portion,
wherein an angle formed by an extension line of the axis at the inflow portion and the axis at the outlet of the second outflow portion is 45 degrees,
a middle portion of the second connection pipe is bent, and the bent second connection pipe includes one part of the second connection pipe and another part of the second connection pipe,
the one part of the second connection pipe is close to the second outflow portion and the another part of the second connection pipe is away from the second outflow portion, and
an angle formed by an extension line of a longitudinal axis of the one part of the second connection pipe and a longitudinal axis of the another part of the second connection pipe is 45 degrees.
